(19) United States
(12) Patent Application Publication
(10) Pub. No.: US 2009/0122067 A1
(43) Pub. Date: May 14, 2009

(54) OPEN FONTS INCLUDING HUMAN-READABLE FONTS FOR COMPILATION

(75) Inventors: Robert L. Beck, Seattle, WA (US); Benjamin Fullerton, Redmond, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 11/938,785

(22) Filed: Nov. 13, 2007

(51) Int. Cl. G06T 11/00

(52) U.S. Cl. 345/467

(57) ABSTRACT

Described is a technology by which an open font type (e.g., comprising human-readable script) may be compiled into compiled font code (e.g., by a just-in-time, or JIT compiler) and used to provide a font for use by a requesting program. In one example, upon receiving a request to load a font, a determination is made as to whether the font is a traditional type or an open type. If a traditional type, a reference to the traditional font is returned to facilitate loading of the font for use by the requesting program. If an open type, a determination is made as to whether the open type font is already compiled and cached as font code; if so, the cached compiled font code is referenced, without compiling. Otherwise the open font is compiled into compiled font code and cached, and the now-cached compiled font code is referenced.

### BACKGROUND

Font files, used for visually rendering text on a host computing device, are specially crafted resource files. Many modern font file are specially crafted dynamic link library (DLL) files with exported resource sections. This has caused some problems with the security of host devices in the past, because DLL files contain executable code that the system can use to perform operations; some of this code is executed when the file is initially loaded. While font files themselves are designed to only provide resources in the DLL files, attackers have found ways to insert malicious executable code stubs into these font files that lead to the compromise of the host device making use of the font.

At the same time, because font files are typically in a compiled binary form, analyzing font files for potential security issues has proven difficult for forensics investigators and security researchers. The security problem is further compounded by the fact that a variety of font files are freely available for download and use on the internet, whereby a forensic investigator is challenged with identifying possibly malicious files on a host device that may contain hundreds of font resources that were not present on a host during its initial operating system installation.

### SUMMARY

This Summary is provided to introduce a selection of representative concepts in a simplified form that are further described below in the Detailed Description. This Summary is not intended to identify key features or essential features of the claimed subject matter, nor is it intended to be used in any way that would limit the scope of the claimed subject matter.

Briefly, various aspects of the subject matter described herein are directed towards a technology by which an open font type (e.g., human-readable) may be compiled into compiled font code and used to provide a font for a requesting program. Upon a request to load an open font type, the open font type is compiled into compiled font code, and the compiled font code loaded for use. In one example implementation, a just-in-time compiler is used.

In one example aspect, font load request handling logic processes a request to load a font type. If the font load request is associated with an open file type, a compiler coupled to the font load request handling logic provides provide compiled font code. A loading mechanism coupled the font load request handling logic loads a traditional file type, or loads the compiled font code corresponding to the open font type, based upon a reference provided to the loading mechanism.

In one example aspect, upon receiving a request to load a font, a determination is made as to whether the font is a traditional type or an open type. If a traditional type, a reference to the traditional font is returned to facilitate loading of the font. If an open type, a determination is made as to whether the font is already compiled and cached as font code. If so the cached compiled font code is referenced to facilitate loading of the font without compiling, otherwise the open font is compiled into compiled font code and cached before being referenced.

Other advantages may become apparent from the following detailed description when taken in conjunction with the drawings.

### BRIEF DESCRIPTION OF THE DRAWINGS

The present invention is illustrated by way of example and not limited in the accompanying figures in which like reference numerals indicate similar elements and in which:

FIG. 1 is a block diagram representing aspects of compiling an open font into compiled font code.

FIG. 2 is a representation of various components that may be used to compile an open font into compiled font in a just-in-time compilation environment.

FIG. 3 is a flow diagram representing example steps taken to load a font, including when loading font code compiled from an open font.

FIGS. 4A-4G are representations of how a font character (the letter “A”) may be created with an open font in the form of script.

FIG. 5 shows an illustrative example of a computing environment into which various aspects of the present invention may be incorporated.

### DETAILED DESCRIPTION

Various aspects of the technology described herein are generally directed towards an open font type, such as one written in the form of human readable code (e.g., script, XML, XAML or the like), that is thereafter compiled into executable font code (e.g., an executable binary such as a DLL). An aspect thus provides a source form of the font resource to be analyzed and/or or maintained on a computer system, exposing the resource's internal construction. Additionally, another aspect allows font authors the ability to produce font resources for application programs or operating systems without the need for potentially costly font creation packages that are presently needed to compile a font into its binary form.

In one example implementation described below, compilation may take place when the font resource is requested by an application program or the operating system, such as via a Just-in-Time (JIT) compilation system available with Microsoft Corporation operating systems. However, an alternative is to have an auditor or the like conduct a review process on the full data (e.g., in script form) of an open font, regardless of its source, and then if the reviewed data meets audit requirements, the font may be independently compiled and made available to network users or the like.

Thus, while various examples herein are primarily described with respect to just-in-time compilation, the technology herein is not limited to any type of compilation. Further, any type of open font that can be compiled may be used, whether “open” refers to directly human readable, indirectly human readable (e.g., via a trusted converter) or machine-reviewable. As such, the present invention is not limited to any particular embodiments, aspects, concepts, structures, functionalities or examples described herein. Rather, any of the embodiments, aspects, concepts, structures, functionalities or examples described herein are non-limiting, and the present invention may be used various ways that provide benefits and advantages in computing and font usage in general.

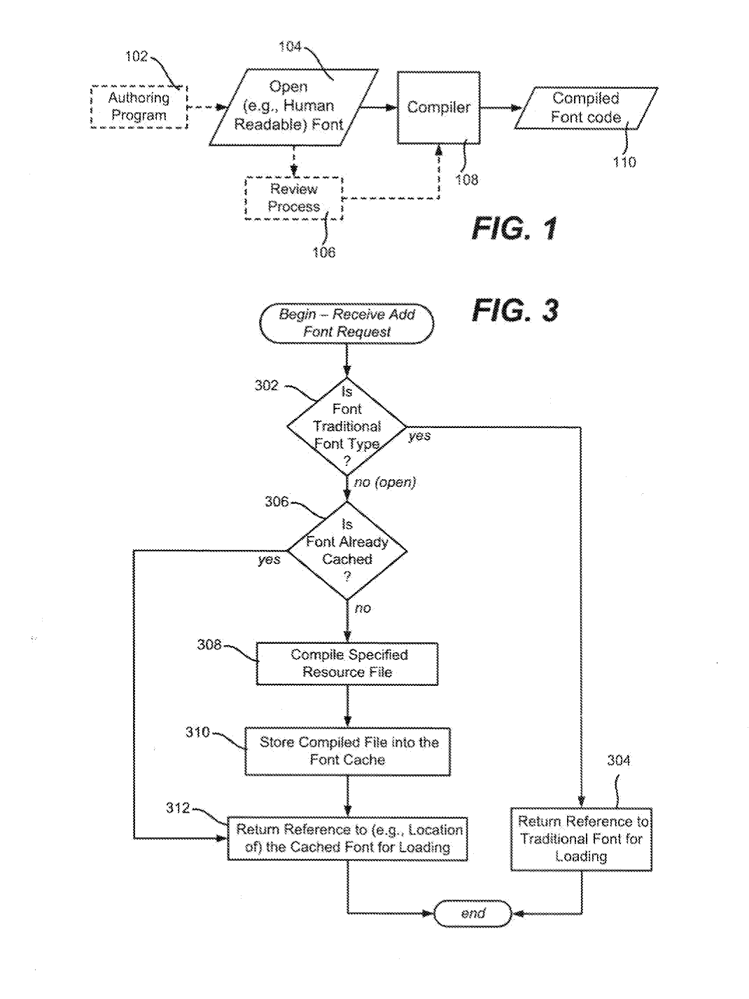

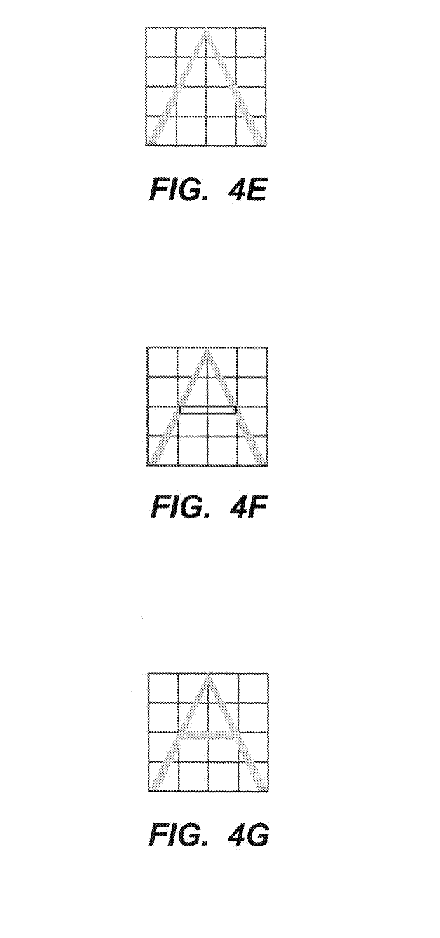

Turning to FIG. 1, there is shown example components by which a font author uses an authoring program 102 to generate an open font 104. (A simplified example of such a font is described below with reference to FIGS. 4A-4G.) Also represented in FIG. 1 is a review process 106, which may be manual or performed by a machine. The review process 106 may vary, such as dependent on the desired level of security and/or the source (if known). For example, open fonts may be carefully reviewed by auditors or the like if to be used in a secure network when the source of the open font is not verified (e.g., signed) as reputable. Another system may use just-in-time compilation that compiles the open font in a manner where the compiled font code will be limited as to what actions it can perform, and thus a more cursory review (if any) may be the extent to which is performed. Note that in FIG. 1 the authoring program 102 and review process 106 are shown as dashed blocks, to indicate that authoring and/or review need not be (and likely will not be) performed at the same time as compilation.

In the event the open font 104 is deemed acceptable to use, a compiler 108 compiles the open font into compiled font code 110. This may be in advance of actual use, or as needed (just-in-time) by a program.

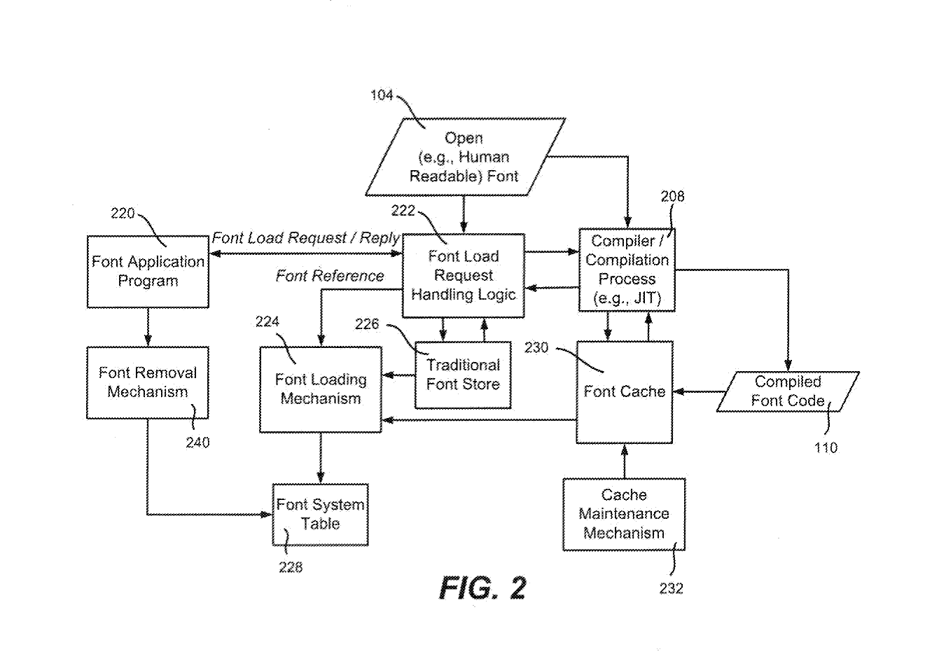

FIG. 2 shows an example implementation in which the open font 104 may be used in a just-in-time compilation environment. In general, a font application program 220 (which may be an operating system component) requests to font request handling logic 222 that a font be added for use. For example, an API call (e.g., to one of the API functions ‘AddFontResource( )’ or ‘AddFontResourceEx( )’) is handled by underlying API code containing the font request handling logic 222.

The loading of font resources may operate in generally the same way as existing font resource loading, with the inclusion of an optional compilation step, if needed, e.g., based on the requested font resource's file type. In this example, the font request handling logic 222 determines whether the requested font resource file type corresponds to a traditional one or an open one that is designed to be processed through the just-in-time compilation process/compiler 208. If a traditional font is requested, the font is loaded as is typical, e.g., by a font loading mechanism 224 (e.g., associated with the load request handling logic 222) from a traditional font store 226, with a reference thereto placed in a font system table 228.

If instead the requested font is an open font 104, the compilation process/compiler 208 determines if this font has previously been compiled and is cached in a font cache 230, that is, is already in a usable, compiled cache form. For example, the font cache 230 may comprise cached font files that may reside in a temporary or other font file folder. If a corresponding compiled font is cached, accessing the compiled and cached font resource eliminates the need to recompile the font resource every time it is needed by an application or system. The font cache 230 may be maintained by a cache maintenance mechanism 232 or the like, to delete files or otherwise clean up the cache as appropriate, e.g., when the computer system is shutting down, if a cached font resource is determined to have not been used for a certain period of time, or is no longer needed (e.g., no more application references to this font resource exists on the system).

If the compilation process/compiler 208 determines that the requested open font needs to be compiled, the compiler compiles the open font into the compiled font code 110. The compiled font code 110 may then be cached in the font cache 230.

Whether compiled and then placed in the font cache 230 or previously determined to have been cached, further operation may be similar to traditional font loading, e.g., a reference (e.g., the location of this cached font resource) is returned to the font loading mechanism 224 for loading and allocation into the system font table 228.

Note that when the font resource is no longer needed by the application and/or the system, a call to font removal mechanism 240 may be made. For example, the API function ‘RemoveFontResource( )’ or ‘RemoveFontResourceEx( )’ may correspond to code that unloads an identified font from the system font table 228.

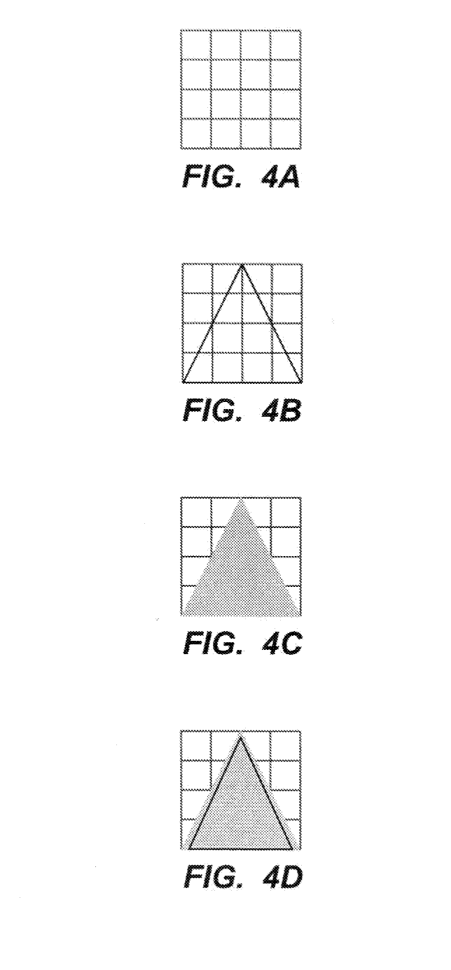

FIG. 3 summarizes the operation of the font request handling logic 222 and compiler/compilation process 208, beginning when a call (e.g., ‘AddFontResource( )’ or ‘AddFontResourceEx( )’) is made to load a font resource. Step 302 evaluates whether the specified font resource is a traditional format, not requiring compilation. If so, step 302 branches to step 304 where the font is loaded, e.g., by returning a reference to the font loading mechanism 224.

If instead at step 302 the specified font resource is determined to be a type requiring compilation, the resource is provided to the just in time font compilation process/compiler 208. At step 306 the font compilation process/compiler 208 determines if this font resource was previously compiled for use on the system and if the compiled cached form of this font resource is available. Note that alternatively, steps 302 and 306 may be combined if an already compiled and cached font is considered to be one in a traditional format.

If the requested font is available in the font cache 230, step 306 branches to step 312 to return a reference (e.g., the location of this cached font resource) for loading and allocation into the system font table 228. For example, the location may be returned back to the ‘AddFontResource( )’ or ‘AddFontResourceEx( )’ API for loading and allocation.

If instead at step 306 no cached form of the specified font resource is available, the compilation process/compiler 208 compiles the open font resource at step 308, and at step 310 stores the compiled resource into the font cache 230, e.g., a file system folder. At step 312 the compilation process/compiler 208 returns a reference to the stored cache file back to ‘AddFontResource( )’ or ‘AddFontResourceEx( )’ for loading and allocation into the system font table 228.

As can be readily appreciated, by incorporating font usage on a host computer system, the system is provided with a level of transparency which facilitates security. Moreover, authors and other users may create fonts on their own, without the need for costly commercial font creation packages.

Turning to an example of how script may be used to generate an open font, an example described in FIGS. 4A-4G are provided; this example assumes that font creation is being performed in relative percentages to ensure proper font scaling and alignment. The objects, functions, and settings utilized in the following VBscript are only examples, and do not currently exist in any known capacity.

The example script used in this example is set forth below as a whole for the purposes of clarity; thereafter, individual pieces of this script are separately described:

‘ Language VBscript
‘ Create a new font object
dim myFont = CreateObject(“FontCollection”)
‘ Provide a name for the font
myFont.Name = “Example Font”
‘ Create a new character in the font collection
‘ for ASCII value ‘65’ which typically is ‘A’
set FontCharacter = myFont.NewChar(65)
‘ Create an image mask object
set myMask = FontCharacter.Mask
‘ Create a triangle
set myMaskTriangle1 = myMask.Create(TRIANGLE)
myMaskTriangle1.Point_A(0,50)
myMaskTriangle1.Point_B(100,0)
myMaskTriangle1.Point_C(100,100)
‘ Create another triangle
set myMaskTriangle2 = myMask.Create(TRIANGLE)
myMaskTriangle2.Point_A(10,50)
myMaskTriangle2.Point_B(100,10)
myMaskTriangle2.Point_C(100,90)
‘ Subtract the second triangle from the first
myMaskTriangle1.Clip(myMaskTriangle2)
‘ Create a box (rectangle)
set myMaskBox = myMask.Create(BOX)
myMaskBox.Points(40,25,20,50)
‘ Add the box to the triangle
myMaskTriangle1.Merge(myMaskBox)
‘ Add the triangle object to the mask
myMask.Cast(myMaskTriangle1)
‘ Finalize the font mask for this character
myMask.Close
‘ Repeating process for all characters (..)

Script part one explanation:

‘ Language VBscript
‘ Create a new font object
dim myFont = CreateObject(“FontCollection”)
‘ Provide a name for the font
myFont.Name = “Example Font”
‘ Create a new character in the font collection
‘ for ASCII value ‘65’ which typically is ‘A’
set FontCharacter = myFont.NewChar(65)
‘ Create an image mask object
set myMask = FontCharacter.Mask

The above script may be used to create a variable of type ‘FontCollection’—this variable stores the information about the font. The second line of script provides a name of the font that could be easily recognized (human readable).

After the script font has been named, a new character in the font collection is created, in this example a new character is created for the ASCII value of decimal “65” which typically equates to the letter “A” (note that this may be changed to allow for double-byte Unicode characters to permit international character fonts).

Once the new character is created, a fontmask is instantiated; this is the visual representation of the font in memory (depicted starting at FIG. 4A as a blank area; the grid is shown for visual aid only).

By utilizing simple shapes and relative co-ordinates a scripter/developer can begin creating a visual font mask. In the following lines a triangle shape is created. Because a triangle has three points that form the triangle, a first step is to determine the location of the first point using relative coordinate (by percentage of drawing area). This example places the first point at 0% vertical (absolute top) and 50% horizontal (absolute middle). The next point of this triangle is set at 100% vertical (absolute bottom) and 0% horizontal (absolute left). The third point of the triangle appears at 100% vertical (absolute bottom) and 100% horizontal (absolute right). The resulting coordinate triangle forms an outline as generally depicted in FIG. 4B. Once filled, the triangle appears in the font mask as represented in FIG. 4C.

‘ Create a triangle
set myMaskTriangle1 = myMask.Create(TRIANGLE)
myMaskTriangle1.Point_A(0,50)
myMaskTriangle1.Point_B(100,0)
myMaskTriangle1.Point_C(100,100)

In general, the next steps in this process involve taking the created shape and altering it to a more visually appealing representation of the letter “A” in the font collection. To this end, a new triangle is created, with the first point of the triangle being placed 10% vertical (10% from the top) and 50% horizontal (absolute middle). The second point of this triangle is placed at 100% vertical (absolute bottom) and 10% horizontal (10% in from the left most edge). The third point of the triangle is placed at 100% vertical (absolute bottom) and 90% horizontal (90% from the left most edge, which is 10% from the right most edge).

‘ Create another triangle
set myMaskTriangle2 = myMask.Create(TRIANGLE)
myMaskTriangle2.Point_A(10,50)
myMaskTriangle2.Point_B(100,10)
myMaskTriangle2.Point_C(100,90)

As generally represented in FIG. 4D, the resulting triangle is a smaller triangle within the bounds of the originally created triangle in the font mask. Next the shapes are manipulated to form an entirely new shape.

Taking the space which is occupied by the second triangle, the space from the original triangle is subtracted, represented below by the ‘Clip’ operator. The resulting visual representation is represented in FIG. 4E, which as can be seen provides the outer portions of the letter “A”:

‘ Subtract the second triangle from the first
myMaskTriangle1.Clip(myMaskTriangle2)

Next a new shape is introduced, a rectangular (box) shape. As boxes have four unique points, the shape is represented with four unique parameters. The first parameter, “(50,”, indicates that the first point of the box is to be at 50% vertical (absolute middle). The second parameter, “25”, indicates that the second point of the box is placed at 25% horizontal (25% in from the left most edge). The third parameter, “10”, indicates that the box has a height equal to 10% of the drawing area's height. The fourth parameter, “50)” indicates that the box has a width of 50% of the drawing area's width. FIG. 4F generally represents such a box shape.

Rather than subtracting the new shape from the initial image, the new shape is merged to the existing image mask (expressed here with the operator ‘Merge’). The resulting image mask (depicted in FIG. 4F) is now easily identified as the letter “A”.

‘ Create a box (rectangle)
set myMaskBox = myMask.Create(BOX)
myMaskBox.Points(50,25,10,50)
‘ Add the box to the triangle
myMaskTriangle1.Merge(myMaskBox)

The font mask is then cast to the actual mask object of the font. The display location is set and the font is closed (saved). The ‘DisplayLocation’ is called out only for example purposes here, but in theory is the location relative to the display line of the font, allowing the developer to make lower case characters and special characters appear below the display area of other characters (example text: “Yy” in which the lower case letter has the effect of a descender).

‘ Add the triangle object to the mask
myMask.Cast(myMaskTriangle1)
‘ Specify the character position/justification relative to
the display line
myMask.DisplayLocation(0,0)
‘ Finalize the font mask for this character
myMask.Close
‘ Repeat process for all characters (..)

### Exemplary Operating Environment

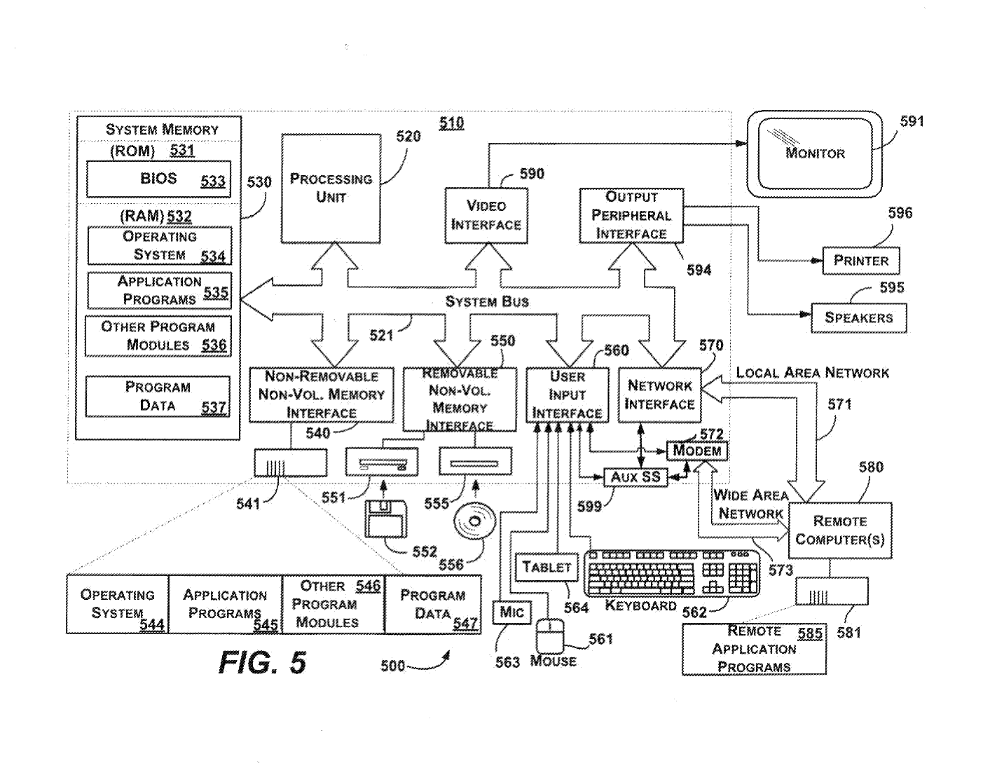

FIG. 5 illustrates an example of a suitable computing system environment 500 on which the examples of FIGS. 1-4G may be implemented. The computing system environment 500 is only one example of a suitable computing environment and is not intended to suggest any limitation as to the scope of use or functionality of the invention. Neither should the computing environment 500 be interpreted as having any dependency or requirement relating to any one or combination of components illustrated in the exemplary operating environment 500.

The invention is operational with numerous other general purpose or special purpose computing system environments or configurations. Examples of well known computing systems, environments, and/or configurations that may be suitable for use with the invention include, but are not limited to: personal computers, server computers, hand-held or laptop devices, tablet devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, and so forth, which perform particular tasks or implement particular abstract data types. The invention may also be practiced in distributed computing environments where tasks are performed by remote processing devices that are linked through a communications network. In a distributed computing environment, program modules may be located in local and/or remote computer storage media including memory storage devices.

With reference to FIG. 5, an exemplary system for implementing various aspects of the invention may include a general purpose computing device in the form of a computer 510. Components of the computer 510 may include, but are not limited to, a processing unit 520, a system memory 530, and a system bus 521 that couples various system components including the system memory to the processing unit 520. The system bus 521 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer 510 typically includes a variety of computer-readable media. Computer-readable media can be any available media that can be accessed by the computer 510 and includes both volatile and nonvolatile media, and removable and non-removable media. By way of example, and not limitation, computer-readable media may comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by the computer 510. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

The system memory 530 includes computer storage media in the form of volatile and/or nonvolatile memory such as read only memory (ROM) 531 and random access memory (RAM) 532. A basic input/output system 533 (BIOS), containing the basic routines that help to transfer information between elements within computer 510, such as during start-up, is typically stored in ROM 531. RAM 532 typically contains data and/or program modules that are immediately accessible to and/or presently being operated on by processing unit 520. By way of example, and not limitation, FIG. 5 illustrates operating system 534, application programs 535, other program modules 536 and program data 537.

The computer 510 may also include other removable/non-removable, volatile/nonvolatile computer storage media. By way of example only, FIG. 5 illustrates a hard disk drive 541 that reads from or writes to non-removable, nonvolatile magnetic media, a magnetic disk drive 551 that reads from or writes to a removable, nonvolatile magnetic disk 552, and an optical disk drive 555 that reads from or writes to a removable, nonvolatile optical disk 556 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 541 is typically connected to the system bus 521 through a non-removable memory interface such as interface 540, and magnetic disk drive 551 and optical disk drive 555 are typically connected to the system bus 521 by a removable memory interface, such as interface 550.

The drives and their associated computer storage media, described above and illustrated in FIG. 5, provide storage of computer-readable instructions, data structures, program modules and other data for the computer 510. In FIG. 5, for example, hard disk drive 541 is illustrated as storing operating system 544, application programs 545, other program modules 546 and program data 547. Note that these components can either be the same as or different from operating system 534, application programs 535, other program modules 536, and program data 537. Operating system 544, application programs 545, other program modules 546, and program data 547 are given different numbers herein to illustrate that, at a minimum, they are different copies. A user may enter commands and information into the computer 510 through input devices such as a tablet, or electronic digitizer, 564, a microphone 563, a keyboard 562 and pointing device 561, commonly referred to as mouse, trackball or touch pad. Other input devices not shown in FIG. 5 may include a joystick, game pad, satellite dish, scanner, or the like. These and other input devices are often connected to the processing unit 520 through a user input interface 560 that is coupled to the system bus, but may be connected by other interface and bus structures, such as a parallel port, game port or a universal serial bus (USB). A monitor 591 or other type of display device is also connected to the system bus 521 via an interface, such as a video interface 590. The monitor 591 may also be integrated with a touch-screen panel or the like. Note that the monitor and/or touch screen panel can be physically coupled to a housing in which the computing device 510 is incorporated, such as in a tablet-type personal computer. In addition, computers such as the computing device 510 may also include other peripheral output devices such as speakers 595 and printer 596, which may be connected through an output peripheral interface 594 or the like.

The computer 510 may operate in a networked environment using logical connections to one or more remote computers, such as a remote computer 580. The remote computer 580 may be a personal computer, a server, a router, a network PC, a peer device or other common network node, and typically includes many or all of the elements described above relative to the computer 510, although only a memory storage device 581 has been illustrated in FIG. 5. The logical connections depicted in FIG. 5 include one or more local area networks (LAN) 571 and one or more wide area networks (WAN) 573, but may also include other networks. Such networking environments are commonplace in offices, enterprise-wide computer networks, intranets and the Internet.

When used in a LAN networking environment, the computer 510 is connected to the LAN 571 through a network interface or adapter 570. When used in a WAN networking environment, the computer 510 typically includes a modem 572 or other means for establishing communications over the WAN 573, such as the Internet. The modem 572, which may be internal or external, may be connected to the system bus 521 via the user input interface 560 or other appropriate mechanism. A wireless networking component 574 such as comprising an interface and antenna may be coupled through a suitable device such as an access point or peer computer to a WAN or LAN. In a networked environment, program modules depicted relative to the computer 510, or portions thereof, may be stored in the remote memory storage device. By way of example, and not limitation, FIG. 5 illustrates remote application programs 585 as residing on memory device 581. It may be appreciated that the network connections shown are exemplary and other means of establishing a communications link between the computers may be used.

An auxiliary subsystem 599 (e.g., for auxiliary display of content) may be connected via the user interface 560 to allow data such as program content, system status and event notifications to be provided to the user, even if the main portions of the computer system are in a low power state. The auxiliary subsystem 599 may be connected to the modem 572 and/or network interface 570 to allow communication between these systems while the main processing unit 520 is in a low power state.

### CONCLUSION

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

What is claimed is:

1. A computer-readable medium having computer-executable instructions, which when executed perform steps, comprising:
receiving a request to load an open font type;
compiling the open font type into compiled font code; and
loading the compiled font code.

2. The computer-readable medium of claim 1 wherein compiling the open font into the compiled font code comprises providing the open font type to a just-in-time compiler.

3. The computer-readable medium of claim 1 having further computer-executable instructions comprising, caching the compiled font code into a storage location.

4. The computer-readable medium of claim 3 having further computer-executable instructions comprising, receiving another request to load the open font type, determining that the compiled font code corresponding to the open font type is already compiled font code cached in the storage location, and loading the compiled font code based on the compiled font code cached in the storage location.

5. In a computing environment, a system comprising:
font load request handling logic that processes a request to load a font type;
a compiler coupled to the font load request handling logic, the font load request handling logic requesting the compiler to provide compiled font code when the font load request is associated with an open file type; and
a loading mechanism coupled the font load request handling logic to load a traditional file type, or load the compiled font code corresponding to the open font type, based upon a reference provided to the loading mechanism.

6. The system of claim 5 wherein the compiler comprises a just-in-time compiler.

7. The system of claim 5 wherein the compiler provides the compiled font code by compiling the open file type.

8. The system of claim 5 further comprising a font cache coupled to the compiler, the compiler providing the compiled font code as a reference to a file in the cache that corresponds to the open font type as compiled by the compiler into the compiled font code.

9. The system of claim 8 wherein the compiler comprises a just-in-time compiler, wherein the compiler determines whether a file in the cache that corresponds to the open font type exists, and if not, compiles the open file type into compiled font code as a file in the cache before providing the reference to the file.

10. The system of claim 8 further comprising a cache maintenance mechanism that deletes the file from the cache.

11. The system of claim 5 further comprising a system font table coupled to the loading mechanism, the loading mechanism writing data to the system font table based on the reference provided to the loading mechanism.

12. The system of claim 5 further comprising a removal mechanism that removes the data from the system font table.

13. The system of claim 5 wherein the open file type corresponds to human-readable data including code.

14. The system of claim 13 wherein the human-readable data comprises script.

15. The system of claim 11 wherein the font load request handling logic and loading mechanism are associated with an application programming interface called by a program.

16. The system of claim 5 wherein the font load request handling logic processes the request to load a font type by evaluating a file type to determine whether the font load request corresponds to a traditional file type or to an open font type.

17. In a computing environment, a method comprising:
receiving a request to load a font;
determining whether the font is a traditional type or an open type, and
a) if a traditional type, returning a reference to the traditional font; or
b) if an open type, determining whether the font is compiled and cached font code, and if so, advancing to step b)i), and if not, compiling the open font into compiled font code and caching the compiled font code into a cache, and
i) returning a reference to the compiled font code.

18. The method of claim 16 wherein determining whether the font is a traditional type or an open type comprises evaluating a file type associated with the font.

19. The method of claim 16 further comprising, loading and allocating a font for use based on the reference to the traditional font or the reference to the compiled font code.

20. The method of claim 16 further comprising, deleting the compiled font code from the cache.
